(19) United States
(12) Patent Application Publication
(10) Pub. No.: US 2010/0062309 A1
(43) Pub. Date: Mar. 11, 2010

(54) FUEL CELL AND METHOD FOR MANUFACTURING THE SAME

(76) Inventors: Shiro Akiyama, Okazaki-shi (JP); Hitoshi Hamada, Gotenba-shi (JP); Hironori Noto, Tokai-shi (JP); Manabu Takashi, Okazaki-shi (JP); Kenichi Tokuda, Nishikamo-gun (JP); Tsutomu Ochi, Nishikamo-gun (JP); Tsunemasa Nishida, Toyota-shi (JP); Takahiro Nitta, Nishio-shi (JP); Shinji Matsuo, Kiyosu-shi (JP)

Correspondence Address: KENYON & KENYON LLP, 1500 K STREET N.W., SUITE 700, WASHINGTON, DC, 20005, US

(21) Appl. No.: 12/593,535

(22) PCT Filed: Mar. 26, 2008
(86) PCT No.: PCT/JP2008/056506

§ 371 Date: Sep. 28, 2009

(30) Foreign Application Priority Data
Mar. 29, 2007 (JP) 2007-089648

(51) Int. Cl. H01M 8/10

(52) U.S. Cl. 429/30

(57) ABSTRACT

A fuel cell is provided with a membrane-electrode assembly 15 in which catalyst layers 15b as a pair of electrodes are bonded to both the surfaces of an electrolyte membrane 15a, and diffusion layers 16 arranged on both the surfaces of this membrane-electrode assembly 15. The membrane-electrode assembly 15 and the diffusion layer 16s are laminated without bonding at least a part between the membrane-electrode assembly 15 and the diffusion layers 16. Thus, sliding and separating between the catalyst layer 15b and the diffusion layers 16 are allowed.

### TECHNICAL FIELD

The present invention relates to a fuel cell provided with diffusion layers on both the surfaces of a membrane-electrode assembly and a method for manufacturing the fuel cell.

### BACKGROUND ART

There is a fuel cell provided with a membrane-electrode assembly in which catalyst layers as a pair of electrodes are bonded on both sides of an electrolyte membrane, and diffusion layers arranged on both sides of this membrane-electrode assembly. Moreover, a method for manufacturing such a fuel cell includes a technology in which solutions of a diffusion layer, a catalyst layer, an electrolyte membrane, a catalyst layer and a diffusion layer are applied, respectively, laminated in a non-dried state, dried and then integrated (e.g., Japanese Patent Application Laid-Open No. 2004-14202).

### DISCLOSURE OF THE INVENTION

However, in the above technology, a membrane-electrode assembly and diffusion layers are bonded and secured to each other by so-called hot pressing. Therefore, when the difference of a water expansion or a heat expansion is made between an electrolyte membrane of the membrane-electrode assembly and the diffusion layers owing to the formation of water and the generation of heat during power generation, stresses might be applied to catalyst layers interposed between the electrolyte membrane and the diffusion layers, thereby causing breakdown.

To solve the problem, an object of the present invention is to provide a fuel cell capable of alleviating the stresses acting on the catalyst layers, and a method for manufacturing the fuel cell.

To achieve the above object, a fuel cell of the present invention is a fuel cell comprising: a membrane-electrode assembly in which catalyst layers as a pair of electrodes are bonded to both the surfaces of an electrolyte membrane; and diffusion layers arranged on both the surfaces of this membrane-electrode assembly, wherein at least a part of contact surfaces between the membrane-electrode assembly and the diffusion layers along a plane direction has a non-bonding portion.

According to such a constitution, sliding and separating between the catalyst layers and the diffusion layers in the non-bonding portions are allowed. Therefore, even when the difference of a water expansion or a heat expansion is made between the electrolyte membrane of the membrane-electrode assembly and the diffusion layers owing to, for example, the formation of water and the generation of heat during power generation, it is possible to alleviate stresses acting on the catalyst layers interposed between the electrolyte membrane and the diffusion layers.

In this case, a part of the contact surfaces between the membrane-electrode assembly and the diffusion layers has a bonding portion, and the remaining part thereof may be a non-bonding portion.

According to such a constitution, the whole contact surfaces between the membrane-electrode assembly and the diffusion layers are not bonded, but a part of the contact surfaces is bonded, whereby the membrane-electrode assembly and the diffusion layers can be formed into a module, and treating properties can be improved.

Moreover, the contact surfaces of the diffusion layers with respect to the membrane-electrode assembly may be subjected to a smoothening treatment (e.g., pressing) before the diffusion layers are laminated.

According to such a constitution, it is possible to suppress damages (aggressive properties) on the membrane-electrode assembly due to the unevenness, fluffing or the like of the surfaces of the diffusion layers laminated on both the surfaces of the membrane-electrode assembly.

Moreover, a method for manufacturing a fuel cell according to the present invention is a method for manufacturing a fuel cell including a membrane-electrode assembly in which catalyst layers as a pair of electrodes are bonded to both the surfaces of an electrolyte membrane and diffusion layers arranged on both the surfaces of this membrane-electrode assembly, the method comprising: a laminating step of laminating the membrane-electrode assembly and the diffusion layers without bonding at least a part of contact surfaces between the membrane-electrode assembly and the diffusion layers along a plane direction.

According to such a constitution, the fuel cell can be manufactured so as to allow sliding and separating between the catalyst layers and the diffusion layers in a non-bonding portion.

In the laminating step, an adhesive may be applied to a part of the contact surfaces between the membrane-electrode assembly and the diffusion layers.

According to such a constitution, the membrane-electrode assembly and the diffusion layers can be formed into a module, and treating properties in the manufacturing process of the fuel cell can be improved.

The method has a step of subjecting, to a smoothening treatment, the contact surfaces between the diffusion layers and the membrane-electrode assembly among the surfaces of the diffusion layers, and the laminating step may laminate the diffusion layers subjected to the smoothening treatment on both the surfaces of the membrane-electrode assembly.

According to such a constitution, the fuel cell can be manufactured so as to suppress damages (aggressive properties) on the membrane-electrode assembly by the diffusion layers.

According to the present invention, stresses acting on the catalyst layers can be alleviated, and the durability of the catalyst layers, that is, the fuel cell can be improved.

### BRIEF DESCRIPTION OF THE DRAWINGS

FIG. 1 is a side view showing a first embodiment of a fuel cell of the present invention;

FIG. 2 is a sectional side view of each of cells constituting the fuel cell of FIG. 1;

FIG. 3 is a side view of an MEA constituting the fuel cell of FIG. 1;

FIG. 4 is a side view of the MEA and diffusion layers constituting the fuel cell of FIG. 1;

FIG. 5 is an exploded diagram of an MEA and diffusion layers constituting a second embodiment of the fuel cell of the present invention; and

FIG. 6 is a side view of the MEA and the diffusion layers of FIG. 5.

### BEST MODE FOR CARRYING OUT THE INVENTION

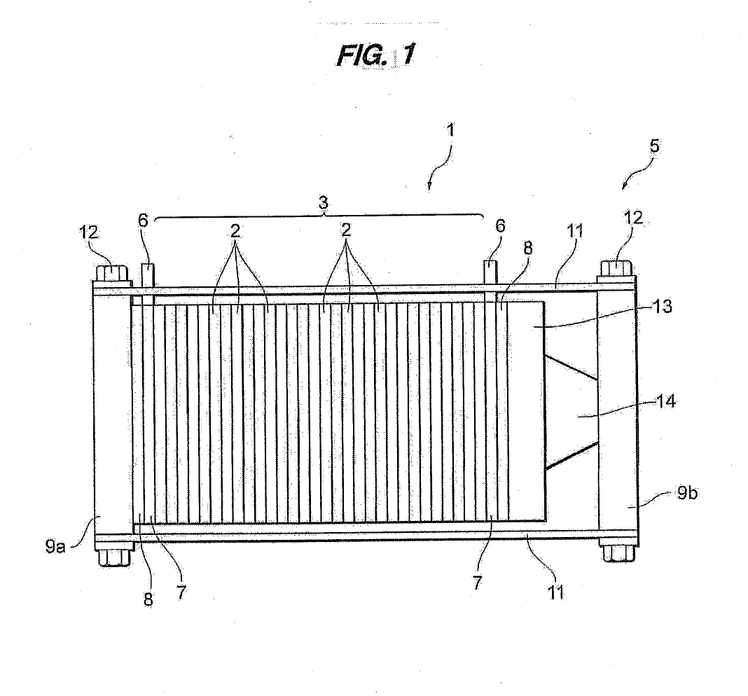

A first embodiment of a fuel cell according to the present invention will be described with reference to FIGS. 1 to 4. A fuel cell 1 of the first embodiment is of a solid polymer type, and includes a stacked main body 3 in which a plurality of cells 2 as basic units are stacked, and a frame 5 which supports the stacked main body 3 as shown in FIG. 1. At one end of the stacked main body 3 along the stacking direction of the cells 2, a terminal plate 7 is disposed, and an insulating plate 8 is disposed outside the terminal plate. Further outside the insulating plate, an end plate 9a constituting the frame 5 is disposed.

Moreover, at the other end of the stacked main body 3, a terminal plate 7 is disposed, and an insulating plate 8 is disposed outside the terminal plate. Further outside the insulating plate, a pressure plate 13 is disposed.

Each of the terminal plates 7 is provided with an output terminal 6. Outside the pressure plate 13, an end plate 9b constituting the frame 5 is disposed away from the pressure plate 13, and between the pressure plate 13 and the end plate 9b, a spring member 14 is interposed.

Between the two end plates 9a and 9b arranged on both sides of the stacked main body 3, a plurality of tension plates 11 are disposed along the stacking direction of the cells 2. Both ends of each tension plate 11 are fixed to the respective end plates 9a, 9b by bolts 12, respectively, and the tension plates constitute the frame 5 together with the two end plates 9a, 9b.

When the two end plates 9a, 9b are connected to each other via the plurality of tension plates 11, a compressive force is introduced to the spring member 14, and the spring member 14 exerts an urging force with respect to the stacked main body 3 in the stacking direction of the cells 2. The plurality of cells 2 are fastened by this urging force. A reactive force against the urging force of the spring member 14 is loaded on the tension plates 11, whereby a tensile force acts on the tension plates 11.

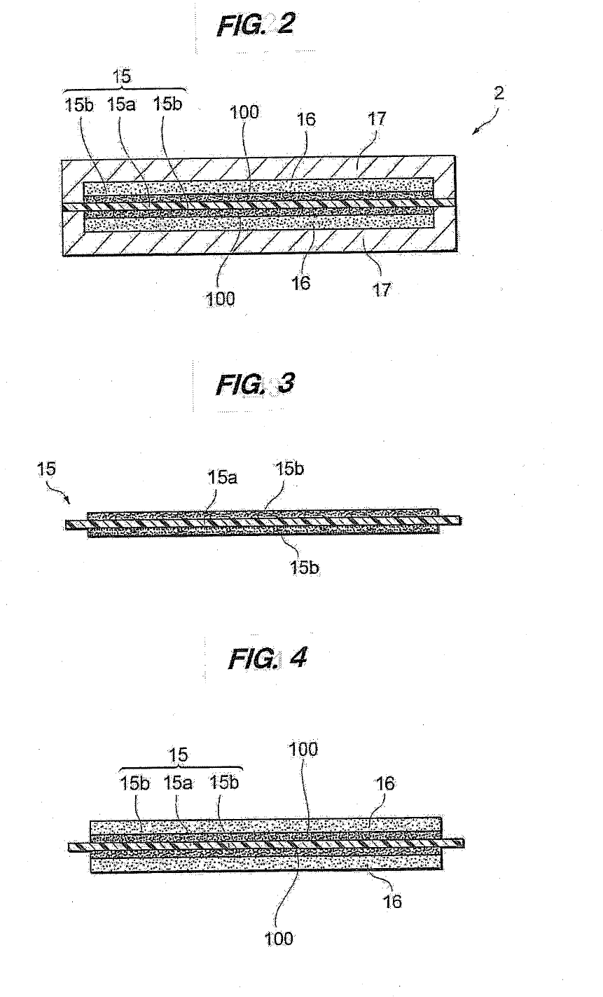

As shown in FIG. 2, each of the cells 2 includes a membrane-electrode assembly (MEA) 15 in which an electrolyte membrane 15a as an ion exchange membrane made of a solid polymer material is sandwiched between catalyst layers 15b as a pair of electrodes, a pair of diffusion layers 16 between which the MEA 15 is sandwiched, and a pair of separators 17 between which the MEA 15 and the pair of diffusion layers 16 are further sandwiched.

The electrolyte membrane 15a is a proton conductive ion exchange membrane made of a polymer material such as a hydrated fluorine carbide or hydrocarbon material, and is specifically made of a perfluorosulfonic acid based resin (Nafion membrane). The catalyst layers 15b are one-size smaller than the electrolyte membrane 15a, and have a catalyst such as platinum or a platinum alloy for promoting an electrochemical reaction.

The diffusion layers 16 are made of a member having a gas permeability and an electron conductivity, for example, carbon paper containing a carbon fiber as a main component. The base material of the separators 17 is made of, for example, carbon, and this material is impregnated with the predetermined amount of a predetermined resin to obtain gas-impermeable carbon based composite separators, and further has a conductivity.

Although not shown, each of the separators 17 is provided with an oxidizing gas passage for supplying an oxidizing gas (usually air) to each catalyst layer 15b through each diffusion layer 16, a hydrogen gas passage for supplying a hydrogen gas, a coolant passage for circulating a coolant (usually water) and the like.

The oxidizing gas supplied to each cell 2 flows into the oxidizing gas passage defined between one of the separators 17 and the diffusion layer 16 adjacent to this separator to come in contact with the catalyst layer 15b as one electrode adjacent to the diffusion layer 16 through this diffusion layer, and the hydrogen gas supplied to each cell 2 flows into the hydrogen gas passage defined between the other separator 17 and the diffusion layer 16 adjacent to this separator to come in contact with the catalyst layer 15b as the other electrode adjacent to the diffusion layer 16 through this diffusion layer. The oxidizing gas and hydrogen gas which have come in contact with both the catalyst layers 15b, respectively, cause the electrochemical reaction in the electrolyte membrane 15a to generate an electromotive force, heat and water.

The electromotive force generated in each cell 2 can be taken from the output terminals 6 provided on the terminal plates 7. The heat generated in each cell 2 is collected by the coolant supplied to each cell 2 through the coolant passage. Water formed by a reaction between the oxidizing gas and the hydrogen gas is discharged from a system together with the remaining oxidizing gas through the oxidizing gas passage.

In the first embodiment, the cell 2 is manufactured as follows. First, as shown in FIG. 3, the catalyst layers 15b are formed on the electrolyte membrane 15a to prepare the MEA 15. For example, carbon powder carrying platinum or the platinum alloy as the catalyst is prepared, and the carbon powder carrying this catalyst is dispersed in an appropriate organic solvent. Nafion solution (e.g., Nafion Solution manufactured by Aldrich Chemical Co., Ltd.) is appropriately added to prepare a paste, and this paste is applied onto the electrolyte membrane 15a by a method such as screen printing, whereby the catalyst layers 15b are formed.

Alternatively, a paste containing the carbon powder carrying the above catalyst is formed into a membrane to prepare a sheet, and the sheet is pressed onto the electrolyte membrane 15a to form the catalyst layers 15b. In either case, the catalyst layers 15b are secured onto the electrolyte membrane 15a.

Next, as shown in FIG. 4, a pair of diffusion layers 16 are arranged on both sides of the MEA 15. At this time, the MEA 15 and the pair of diffusion layers 16 are not bonded to each other but are laminated. That is, the MEA 15 and the pair of diffusion layers 16 are not secured to each other but are only laminated. Afterward, as shown in FIG. 2, the diffusion layers 16 on both sides are further sandwiched between a pair of separators 17 to prepare the cell 2.

According to the above-mentioned first embodiment, the whole contact surfaces between the MEA 15 and the pair of diffusion layers 16 are not secured (bonded), and all the contact surfaces are non-bonding portions 100, whereby in the non-bonding portions 100, sliding and separating between the MEA 15 and the diffusion layers 16 are allowed. Therefore, for example, even when the difference of a water expansion, a heat expansion or the like is made between the electrolyte membrane 15a of the MEA 15 and the diffusion layers 16 owing to the formation of water or the generation of heat accompanying power generation, the stresses acting on the catalyst layers 15b can be alleviated.

That is, the electrolyte membrane 15a contains the water formed during the power generation to immediately expand. In addition, an immediate temperature rise is caused by the heat generated during the power generation, and the electrolyte membrane additionally thermally expands. On the other hand, the diffusion layers 16 do not contain any water to expand, and hardly thermally expand, whereby the inconformity of the expansion is generated between the electrolyte membrane and the diffusion layers.

Here, in the MEA 15, the electrolyte membrane 15a and the catalyst layers 15b are bonded and secured. Therefore, when the catalyst layers 15b and the diffusion layers 16 are bonded and secured, the above inconformity of the expansion needs to be absorbed by the catalyst layers 15b as intermediate layers between the electrolyte membrane and the diffusion layers, but during low-temperature start (especially during start below freezing point), the material hardens, freezes, and hence loses its flexibility, whereby the stresses noticeably act on the catalyst layers 15b as the weakest region to break the layers sometimes. Such a tendency becomes remarkable especially when the start below the freezing point is repeated.

On the other hand, in the fuel cell 1 according to the first embodiment, the MEA 15 and the pair of diffusion layers 16 are not bonded to each other but are only laminated, whereby in these non-bonding portions 100, sliding between the catalyst layers 15b of the MEA 15 and the diffusion layers 16 in a plane direction is allowed. Therefore, the breakdown generated in the catalyst layers 15b can be suppressed, and the durability of the fuel cell 1 can be improved.

Moreover, by the freezing of the water formed in a cooling process below the freezing point and during the start below the freezing point, ice is formed in a frost column-like manner in a direction vertical to the plane direction in the cells 2 sometimes. Even in this case, when the catalyst layers 15b and the diffusion layers 16 are bonded and secured, the push-up force of the ice is concentrated on the catalyst layers 15b as the weakest region, and the layers might break down. However, in the first embodiment, the MEA 15 and the diffusion layers 16 are not bonded to each other but are only laminated, whereby in these non-bonding portions 100, the separating of the catalyst layers 15b of the MEA 15 from the diffusion layers 16 is allowed in the direction vertical to the plane direction, so that the non-bonding portions 100 can be provided with a space for allowing the freezing in the frost column-like manner.

Therefore, also from this respect, the breakdown generated in the catalyst layers 15b can be suppressed, and the durability of the fuel cell 1 can be improved. It is to be noted that in this case, the separating of the catalyst layers 15b of the MEA 15 from the diffusion layers 16 in the direction vertical to the plane direction might temporarily cause a conduction defect and lower the performance of the cells. However, after a temperature rises above the freezing point, the layers come in contact with one another again, and hence usual power generation characteristics can be obtained.

Furthermore, the MEA 15 and the diffusion layers 16 are not hot-pressed, whereby thermal and mechanical damages on the electrolyte membrane 15a of the MEA 15 are alleviated, and the durability is further improved.

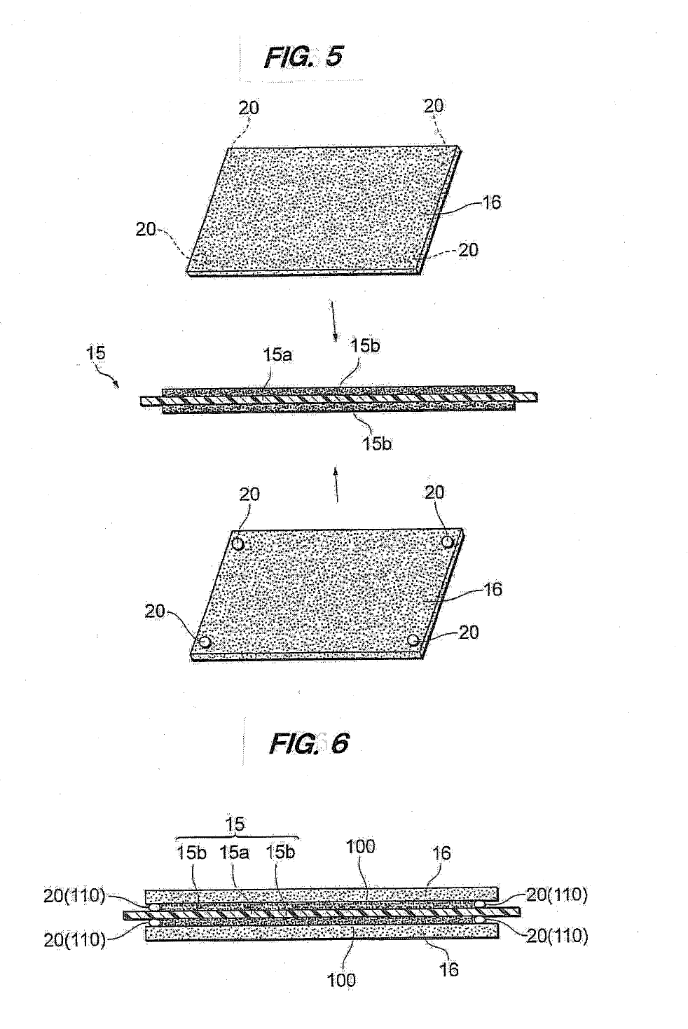

Next, a second embodiment of a fuel cell according to the present invention will be described mainly with respect to parts different from the first embodiment, mainly with reference to FIGS. 5 and 6.

In the first embodiment, the MEA 15 and the diffusion layers 16 are not absolutely bonded to each other but are only laminated, but in the second embodiment, a part of contact surfaces between them is bonded to obtain bonding portions 110 (see FIG. 6) in a secured state, and the remaining part thereof is not bonded but is only laminated to obtain non-bonding portions 100.

That is, the MEA 15 has the above-mentioned constitution in which catalyst layers 15b one-size smaller than an electrolyte membrane 15a are secured to both the surfaces of the electrolyte membrane, but as shown in FIGS. 5 and 6, each of the diffusion layers 16 is one-size larger than the catalyst layer 15b, and an adhesive 20 is applied to several portions of the surfaces of the respective diffusion layers 16 facing portions of the electrolyte membrane 15a protruding externally from catalyst layers 15b, respectively. Specifically, the adhesive is applied to four portions on the inner side of corners of each facing surface of the diffusion layer in a point-like manner.

In consequence, when the diffusion layers 16 are laminated on both the surfaces of the MEA 15, the diffusion layers 16 are bonded to the electrolyte membrane 15a by the adhesive 20, and only portions of the diffusion layers provided with the adhesive 20 are the bonding portions 110 having the secured state. Here, as the adhesive 20 for use, an adhesive which can be assimilated by the material of the catalyst layers 15b is used. Specifically, Nafion solution used during the preparation of the above catalyst layers 15b is applied in the point-like manner.

It is to be noted that applying conditions such as the amount of the adhesive 20 to be applied and an applying area are appropriately set so that the sliding and separating between the catalyst layers 15b of the MEA 15 and the diffusion layers 16 can be allowed, thereby suppressing the breakdown of the catalyst layers 15b after cooling and securing, and so that the bonding portions 110 between the MEA 15 and the diffusion layers 16 are provided with a light adhesive force to such an extent that the MEA 15 and the diffusion layers 16 can integrally be treated in a laminated state during the assembling or disassembling operation of the cells 2.

According to the above second embodiment, the MEA 15 and the diffusion layers 16 are partially bonded by the adhesive 20. In other words, the MEA 15 and the diffusion layers 16 are formed into a module by interposing the bonding portions 110, whereby the MEA 15 and the diffusion layers 16 can integrally be treated, and treating properties during the assembling operation or the disassembling operation can be improved.

Moreover, the same Nafion solution as the material of the catalyst layers 15b is used as the adhesive 20, and hence an influence on the performance of the cells 2 can be suppressed. Needless to say, an adhesive other than Nafion solution may be used as long as the adhesive can suppress the influence on the performance of the cells 2.

Next, a third embodiment of a fuel cell according to the present invention will be described mainly with respect to parts different from the first embodiment.

In the third embodiment, the MEA 15 and the diffusion layers 16 are not absolutely bonded to each other but are only laminated in the same manner as in the first embodiment, but in the third embodiment, the diffusion layers 16 are hot-pressed (a smoothening treatment) before laminated.

That is, the diffusion layers 16 are made of carbon paper containing a carbon fiber as a main component, whereby the diffusion layers 16 generate unevenness on the surfaces thereof, or the carbon fiber fluffs from the surfaces of the diffusion layers 16. When the diffusion layers are laminated as they are, the carbon fiber pierces the MEA 15 to damage the MEA 15, or produces an anchor effect with respect to the MEA 15. To suppress such a defect, the diffusion layers 16 are hot-pressed so that both the surfaces of each diffusion layer is sandwiched by a press machine in a planar manner.

In consequence, the contact surfaces of the diffusion layers 16 with respect to the MEA 15 among the surfaces of the diffusion layers can be smoothened. Thus, in the present embodiment, the hot-pressed diffusion layers 16 are laminated on the MEA 15 to form cells 2. Needless to say, the diffusion layers 16 and the MEA 15 are not bonded by hot pressing in the same manner as in the first embodiment. However, the diffusion layers 16 and the MEA 15 may partially be bonded to each other in the same manner as in the second embodiment.

According to the above third embodiment, the diffusion layers 16 are hot-pressed and hence smoothened, whereby damages (aggressive properties) on the MEA 15 due to the unevenness or fluffing of the surfaces of the diffusion layers 16 can be suppressed.

In addition, it is possible to suppress the anchor effect produced when the fluffs on the surfaces of the diffusion layers 16 pierce the MEA 15, and hence the sliding and separating between the catalyst layers 15b of the MEA 15 and the diffusion layers 16 can satisfactorily be allowed.

It is to be noted that the smoothening treatment is not limited to the planar hot pressing as long as the unevenness and fluffing of the diffusion layers 16 can be suppressed, and cold pressing may be performed. Furthermore, the treatment is not limited to the planar pressing, and roller pressing for sandwiching each layer between rollers and rotating the rollers or the like may be performed.

1. (canceled)

2. A fuel cell comprising:
a membrane-electrode assembly in which catalyst layers as a pair of electrodes are bonded to both the surfaces of an electrolyte membrane; and diffusion layers arranged on both the surfaces of this membrane-electrode assembly,
wherein at least a part of the contact surfaces between the membrane-electrode assembly and the diffusion layers along a plane direction has a non-bonding portion, and
a part of facing surfaces of the electrolyte membrane of the membrane-electrode assembly and the diffusion layers has a bonding portion, while the catalyst layers are not sandwiched between the electrolyte membrane and the diffusion layers, and the remaining part thereof is a non-bonding portion.

3. (canceled)

4. The fuel cell according to claim 2, wherein the contact surfaces of the diffusion layers with respect to the membrane-electrode assembly are subjected to a smoothening treatment before the diffusion layers are laminated.

5. (canceled)

6. A method for manufacturing a fuel cell, including a membrane-electrode assembly in which catalyst layers as a pair of electrodes are bonded to both the surfaces of an electrolyte membrane and diffusion layers arranged on both the surfaces of this membrane-electrode assembly, the method comprising:
a laminating step of laminating the membrane-electrode assembly and the diffusion layers without bonding at least a part of contact surfaces between the membrane-electrode assembly and the diffusion layers along a plane direction,
wherein the laminating step applies an adhesive to a part of the facing surfaces of the electrolyte membrane of the membrane-electrode assembly and the diffusion layers while the catalyst layers are not sandwiched between the electrolyte membrane and the diffusion layers.

7. (canceled)

8. The method for manufacturing the fuel cell according to claim 6, further comprising:
subjecting the contact surfaces between the diffusion layers and the membrane-electrode assembly among the surfaces of the diffusion layers to a smoothening treatment,
wherein the laminating step laminates the diffusion layers subjected to the smoothening treatment on both surfaces of the membrane-electrode assembly.
